(19) United States
(12) Patent Application Publication
(10) Pub. No.: US 2014/0335624 A1
(43) Pub. Date: Nov. 13, 2014

(54) DETECTION METHOD AND APPARATUS FOR THE TIP OF A CHEMICAL MECHANICAL POLISHING CONDITIONER

(71) Applicant: Kinik Company, Taipei (TW)

(72) Inventors: Jui-Lin CHOU, Hualien County (TW); Chia Chun WANG, New Taipei City (TW); Chia-Feng CHIU, New Taipei City (TW); Wen-Jen LIAO, New Taipei City (TW)

(73) Assignee: Kinik Company, Taipei (TW)

(21) Appl. No.: 14/274,375

(22) Filed: May 9, 2014

(30) Foreign Application Priority Data
May 9, 2013 (TW) 102116517

(51) Int. Cl. G01N 31/22

(52) U.S. Cl. CPC G01N 31/22
USPC 436/5; 422/82.05

(57) ABSTRACT

The present invention relates to a detection method and apparatus for the tip of the chemical mechanical polishing conditioner, which comprises: providing a dyeing apparatus comprising a dyeing layer; providing a chemical mechanical polishing conditioner comprising a substrate, a binding layer, and a plurality of abrasive particles, the abrasive particles fixed on the substrate by the binding layer; making the abrasive particles of the chemical mechanical polishing conditioner toward the dyeing apparatus and provide a downward force, so that the chemical mechanical polishing conditioner is contacted with the dyeing layer; and separating the chemical mechanical polishing conditioner and the dyeing apparatus, so that the abrasive particles with a particular protruding height form dyeing abrasive particles adhered the dyeing layer on their surface, and the dyeing abrasive particles are determined as a defect of destroying the flatness of chemical mechanical polishing conditioner.

### CROSS REFERENCE TO RELATED APPLICATION

This application claims the benefits of the Taiwan Patent Application Serial Number 102116517, filed on May 9, 2013, the subject matter of which is incorporated herein by reference.

### BACKGROUND OF THE INVENTION

1. Field of the Invention

The present invention relates to a detection method and apparatus for the tip of a chemical mechanical polishing conditioner, and more particularly to a chemical mechanical polishing conditioner which may provide a detection of the abrasive particles with a particular protruding height on the chemical mechanical polishing conditioner by a dyeing method detection.

2. Description of Related Art

Chemical mechanical polishing (CMP) is a common polishing process in various industries, which can be used to grind the surfaces of various articles, including ceramics, silicon, glass, quartz, or a metal chip. In addition, with the rapid development of integrated circuits, chemical mechanical polishing becomes one of the common techniques for wafer planarization due to its ability to achieve global planarization.

During the chemical mechanical polishing process of semiconductor, impurities or uneven structure on the surface of a wafer are removed by contacting the wafer (or the other semiconductor elements) with a polishing pad and using a polishing liquid if necessary, through the chemical reaction and mechanical force. When the polishing pad has been used for a certain period of time, the polishing performance and efficiency are reduced because the debris produced in the polishing process may accumulate on the surface of the polishing pad. Therefore, a conditioner can be used to condition the surface of the polishing pad, such that the surface of the polishing pad is re-roughened and maintained at an optimum condition for polishing. FIG. 1 is a schematic diagram of a general chemical mechanical polishing conditioner, comprising: a polishing pad 11, a chemical mechanical polishing conditioner 12 and a wafer 13; wherein the polishing pad is positioned on a rotation platform 10, the wafer 13 is fixed on a wafer carrier 14, and a slurry is provided to the chemical mechanical polishing conditioner through a nozzle 15, so that the polishing pad 11 may be rotated with the rotation platform 10 and the wafer 13 positioned thereon may be performed a polishing process. Meanwhile the polishing pad is performed a condition by the chemical mechanical polishing conditioner 12 to remain the polishing efficiency and service life of the polishing pad.

However, during the chemical mechanical polishing process, a few of the abrasive particles with a particular protruding height are often present on the surface of the chemical mechanical polishing conditioner, and these abrasive particles with a particular protruding height will affect the polishing efficiency of the conditioner to the polishing pad or produce scratches and breakages on the polishing pad, and thereby deteriorating integrated polishing efficiency of the chemical mechanical polishing process. Therefore, it is necessary to implement a detection process to ensure an expected polishing effect achieved in the subsequent steps. It is a known method to use an optical microscope (OM) to perform a visual observation whether a pad conditioner has the abrasive particles with a particular protruding height or not. When the abrasive particles with a particular protruding height are observed, the positions would be marked by a marked method (such as oil pen) and taken a photograph. Finally, the photos taken before and after the grinding process would be compared by a person to mark the correct positions of abrasive particles with a particular protruding height.

In the known technology, it discloses This invention provides a conditioner of a chemical mechanical polishing machine, which comprises: a conditioner substrate; a first conductive layer and a second conductive layer installed in the conditioner substrate, in which the first conductive layer and the second conductive layer are isolated through insulation; a plural number of diamonds infixed into the first conductive layer and the second conductive layer; and an adhesion layer installed on the conditioner substrate to fix the diamonds, in which the first conductive layer and the second conductive layer can be used to detect diamond fall-off, since when the diamonds fall off, conductive material enters the location previously occupied by the diamonds, and short circuit will occur between the first conductive layer and the second conductive layer.

Besides, in the other known technology, it discloses Methods and systems for evaluating and/or increasing CMP pad dresser performance are provided. In one aspect, for example, a method of identifying overly-aggressive superabrasive particles in a CMP pad dresser can include positioning a CMP pad dresser having a plurality of superabrasive particles on an indicator substrate such that at least a portion of the plurality of superabrasive particles of the CMP pad dresser contact the indicator substrate, and moving the CMP pad dresser across the indicator substrate in a first direction such that the portion of the plurality of superabrasive particles create a first marking pattern on the substrate, wherein the first marking pattern identifies a plurality of working superabrasive particles from among the plurality of superabrasive particles.

However, in the above-mentioned chemical mechanical polishing conditioner, the lacking or fallen abrasive particles on the conditioner are detected by a short circuit current or the scratches on the substrate. Therefore, there is an urgent need to develop a detection method and apparatus for the tip of a chemical mechanical polishing conditioner, which cannot only detect and determine whether the chemical mechanical polishing conditioner has abrasive particles with a particular protruding heights or not, but also remove abrasive particles with particular protruding height on the chemical mechanical polishing conditioner, and thereby avoiding scratches and breakages produced on the polishing pad due to the abrasive particles with a particular protruding height during a chemical mechanical polishing process.

### SUMMARY OF THE INVENTION

An object of the present invention is to provide a detection method for the tip of a chemical mechanical polishing conditioner to detect whether the chemical mechanical polishing conditioner has the abrasive particles with a particular protruding height or not, and remove the abrasive particles with a particular protruding height on the chemical mechanical polishing conditioner to achieve the surface flatness of the chemical mechanical polishing conditioner, and thereby avoiding scratches and breakages produced on the polishing pad due to the abrasive particles with a particular protruding height during a chemical mechanical polishing process.

To achieve the above object, the present invention provides a detection method for the tip of a chemical mechanical polishing conditioner, comprising: providing a dyeing apparatus comprising a dyeing layer; providing a chemical mechanical polishing conditioner comprising a substrate, a bonding layer, and a plurality of abrasive particles, and the abrasive particles fixed on the substrate by the bonding layer; making the abrasive particles on the chemical mechanical polishing conditioner toward the dyeing apparatus and providing a downward force, so that the chemical mechanical polishing conditioner is contacted with the dyeing layer; and separating the chemical mechanical polishing conditioner and the dyeing apparatus, so that the abrasive particles with a particular protruding height form dyeing abrasive particles adhered the dyeing layer on their surfaces, and the dyeing abrasive particles are determined as a defect of destroying the flatness of chemical mechanical polishing conditioner.

The present invention is different from the well-known methods for the tip of a chemical mechanical polishing conditioner in which a polishing pad is directly performed a polishing test by the conditioner, or the total areas of the conditioner are performed a check by a person. A person wastes his energy and time on the well-known methods, and the detection results of the well-known methods are still doubtful. On the other hand, if the abrasive particles with a particular protruding height are present on the chemical mechanical polishing conditioner, the scratches and breakages are not only produced on the polishing pad due to the abrasive particles with a particular protruding height during chemical mechanical polishing process, but the abrasive particles with heights less than a particular protruding height also cannot be contacted the polishing pad to perform a condition because of the total polishing process concentrated in a few of the abrasive particles with a particular protruding height, so that the service life of the conditioner is shortened greatly and polishing efficiency of the conditioner is declined greatly. Therefore, in detection method for the tip of a chemical mechanical polishing conditioner, the abrasive particles with a particular protruding height are marked and detected by providing a dyeing method, and the abrasive particles with a particular protruding height are removed from the chemical mechanical polishing conditioner, and thereby avoiding scratches and breakages produced on the polishing pad due to abrasive particles with a particular protruding height during a chemical mechanical polishing process.

In detection method for the tip of a chemical mechanical polishing conditioner, the abrasive particles with a particular protruding height on the chemical mechanical polishing conditioner may be dyed by the dyeing layer to mark and detect the abrasive particles with a particular protruding height. The compositions of dyeing layer may be randomly varied based on the user's requirements or the detection methods; therefore, any dyeing layer compositions or any colors of dyeing layer should be considered to be the scope of the invention, only if the abrasive particles with a particular protruding height may be dyed or marked by any dyeing compositions or any colors of the dyeing layer. The aforementioned compositions of the dyeing layer of present invention may be a powder dyeing layer, an ink dyeing layer, or a fluorescent dyeing layer, but the present invention is not limited thereto. In one aspect of the present invention, the powder dyeing layer is a carbon paper. The colors of the dyeing layer or the dyeing abrasive particles of the present invention may be black, red, blue, or various dayglo, but the present invention is not limited thereto. In one aspect of the present invention, the dyeing layer and the dyeing abrasive particles are black. Besides, in detection method for the tip of a chemical mechanical polishing conditioner of the present invention, the dyeing apparatus further comprises a dyeing platform provided for the dyeing layer remaining a flat surface.

In detection method for the tip of a chemical mechanical polishing conditioner of the present invention, the chemical mechanical polishing conditioner is contacted with the dyeing layer by a downward force, so that the abrasive particles with a particular protruding height form a dyeing abrasive particles adhered the dyeing layer on their surfaces, and the dyeing abrasive particles are determined as a defect of destroying the flatness of chemical mechanical polishing conditioner; wherein an action mode and a movement mode of the downward force may be varied based on varied based on the user's detection requirements or the detection methods. Therefore, any downward forces should be considered to be the scope of the invention, only if the abrasive particles with a particular protruding height form the dyeing abrasive particles adhered the dyeing layer on their surfaces by means of any downward forces. The aforementioned action mode of the downward force of the present invention may be the gravity formed by itself weight of the chemical mechanical polishing conditioner, or the action mode of the downward force may an additional downward gravity applied to the chemical mechanical polishing conditioner, but the present invention is not limited thereto. In one aspect of the present invention, the action mode of the downward force of the present invention may be the gravity formed by itself weight of the chemical mechanical polishing conditioner. In the aforementioned movement mode of the downward force of the present invention may be that a pressure is applied to a fixed position of the dyeing layer by the chemical mechanical polishing conditioner, or a pressure is applied to a non-fixed position of the dyeing layer by the chemical mechanical polishing conditioner; wherein the non-fixed position may represent that the chemical mechanical polishing conditioner is moved by means of a rotation direction movement, a rectilinear direction movement, or a plurality of rectilinear directions crisscrossing movement under the dyeing layer, but the present invention is not limited thereto. In one aspect of the present invention, the movement mode of the downward force is that a pressure is applied to a fixed position of the dyeing layer by the chemical mechanical polishing conditioner.

Herein, term “particular protruding height” may refer to an abrasive particle having the highest protruding tip as a standard height and extend downward (namely, extending toward a direction of the binding layer of the chemical mechanical polishing conditioner or the substrate) to a specific distance from the standard height; therefore, a distance between the standard height and the specific distance may be defined as a particular protruding height, and abrasive particles between the standard height and the specific distance may be defined as abrasive particles with a particular protruding height.

In detection method for the tip of a chemical mechanical polishing conditioner, the particular protruding height may be determined by a thickness of the dyeing layer or a downward force of the chemical mechanical polishing conditioner contracted with the dyeing layer, and the particular protruding height may be varied based on the user's detection requirements or the detection methods. The aforementioned thickness of dyeing layer of the present invention may be 5 μm to 200 μm; therefore, the particular protruding height may be 5 μm to 200 μm. In one aspect of the present invention, the particular protruding height is 10 μm to 30 μm.

In detection method for the tip of a chemical mechanical polishing conditioner, the method further comprises a removing device for removing the abrasive particles with a particular protruding height from the chemical mechanical polishing conditioner to avoid scratches and breakages produced on the polishing pad due to abrasive particles with a particular protruding height during a chemical mechanical polishing process. The aforementioned removing device of the present invention may be a high power laser, a water jet device, an endpoint oscillator or an artificial shave tool, but the present invention is not limited thereto. In one aspect of the present invention, the removing device is the high-power laser. In another aspect of the present invention, the removing device is the artificial shave tool.

Another object of the present invention is to provide a detection apparatus for the tip of a chemical mechanical polishing conditioner, which is used for detecting whether the chemical mechanical polishing conditioner has the abrasive particles with a particular protruding height or not, and the abrasive particles with a particular protruding height may be removed from the chemical mechanical polishing conditioner to achieve the surface flatness of the chemical mechanical polishing conditioner, and thereby avoiding scratches and breakages produced on the polishing pad due to abrasive particles with a particular protruding height during a chemical mechanical polishing process.

To achieve the above object, the present invention provides a detection apparatus for the tip of a chemical mechanical polishing conditioner, comprising a dyeing apparatus comprising dyeing layer; a chemical mechanical polishing conditioner comprising a substrate, a binding layer, and a plurality of abrasive particles fixed on the substrate by the binding layer; wherein these abrasive particles on the chemical mechanical polishing conditioner are toward the dyeing apparatus, and the chemical mechanical polishing conditioner is contacted with the dyeing layer by a downward force; and separating the chemical mechanical polishing conditioner and the dyeing apparatus, so that the abrasive particles with a particular protruding height form dyeing abrasive particles adhered the dyeing layer on their surfaces, and the dyeing abrasive particles are determined as a defect of destroying the flatness of chemical mechanical polishing conditioner.

In a detection apparatus for the tip of a chemical mechanical polishing conditioner, the abrasive particles with a particular protruding height on the chemical mechanical polishing conditioner may be dyed by the dyeing layer to mark and detect the abrasive particles with a particular protruding height. The compositions of the dyeing layer may be varied based on the user's detection requirements or the detection methods; therefore, any compositions of the dyeing layer or any colors of the dyeing layer should be considered to be the scope of the invention, only if the abrasive particles with a particular protruding height may be dyed or marked by any compositions of the dyeing or any colors of the dyeing layer. The aforementioned compositions of the dyeing layer of the present invention may be a powder dyeing layer, an ink dyeing layer, or a fluorescent dyeing layer, but the present invention is not limited thereto. In one aspect of the present invention, the powder dyeing layer is a carbon paper. The colors of the dyeing layer or the dyeing abrasive particles of the present invention may be black, red, blue, or various dayglo, but the present invention is not limited thereto. In one aspect of the present invention, the dyeing layer or the dyeing abrasive particles are black.

In the detection apparatus for the tip of a chemical mechanical polishing conditioner, the apparatus further comprises a dyeing platform having a flat surface, and the dyeing platform is positioned the bottom of the dyeing layer, which is provided for the dyeing layer remaining a flat surface. The aforementioned material of the dyeing platform of the present invention may be a resin material, a ceramics material, a metal material, but the present invention is not limited thereto. In one aspect of the present invention, the dyeing platform is a resin film made from polyacrylate resin. In another aspect of the present invention, the dyeing platform is a metal platform made from an aluminum material or a stainless steel material.

In the detection apparatus for the tip of a chemical mechanical polishing conditioner, the apparatus further comprises a removing device for removing the abrasive particles with a particular protruding height from the chemical mechanical polishing conditioner to avoid scratches and breakages produced on the polishing pad due to abrasive particles with a particular protruding height during a chemical mechanical polishing process. The aforementioned removing device of the present invention may be may a high power laser, a water jet device, an endpoint oscillator or an artificial shave tool, but the present invention is not limited thereto. In one aspect of the present invention, the removing device is the high-power laser. In another aspect of the present invention, the removing device is the artificial shave tool.

In the detection apparatus for the tip of a chemical mechanical polishing conditioner, the materials and sizes of the substrate may be varied based on the user's detection requirements or the detection methods; wherein the materials of the substrate may be stainless steel, mold steel, metal alloy or ceramic material etc., but the present invention is not be limited thereto. In a preferred aspect of the present invention, the material of the substrate may be a type 316 stainless steel.

In the detection apparatus for the tip of a chemical mechanical polishing conditioner, the compositions of the binding layer or the compositions or the sizes of the abrasive particles may be varied based on the polishing processing conditions and requirements; wherein the binding layer may be a brazing layer, a resin layer, a electroplating layer, or a ceramic layer, but the present invention is not limited thereto. In one aspect of the present invention, the binding layer may be a brazing layer. The brazing layer may be at least one selected from the group consisting of iron, cobalt, nickel, chromium, manganese, silicon, aluminum, copper, and combinations thereof. In another aspect of the present invention, the brazing layer is a nickel-based metallic brazing material. Besides, in a detection apparatus for the tip of a chemical mechanical polishing conditioner, the abrasive particles may be diamond or cubic boron nitride; and in a preferred aspect of the present invention, the abrasive particles may be diamond. In addition, in the detection apparatus for the tip of a chemical mechanical polishing conditioner of the present, the abrasive particles may have a particle size of 30 to 600 μm; and in one aspect of the present invention, the abrasive particles may have a particle size of 200 μm.

In summary, according to a detection method and apparatus for the tip of a chemical mechanical polishing conditioner of the present invention, the abrasive particles with a particular protruding height may be marked and detected by providing dyeing method, and the abrasive particles with a particular protruding height may be removed from the chemical mechanical polishing conditioner to achieve the surface flatness of the chemical mechanical polishing conditioner, and thereby avoiding scratches and breakages produced on the polishing pad due to abrasive particles with a particular protruding height during a chemical mechanical polishing process.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows a schematic diagram of a general chemical mechanical polishing equipment.

FIGS. 2A to 2D show a flow diagram of detection method for the tip of a chemical mechanical polishing conditioner of example 1 of the present invention.

FIG. 3 shows a schematic diagram of detection method for the tip of a chemical mechanical polishing conditioner of example 2 of the present invention.

FIGS. 4A and 4B show schematic diagrams of detection method for the tip of a chemical mechanical polishing conditioner of examples 3 and 4 of the present invention.

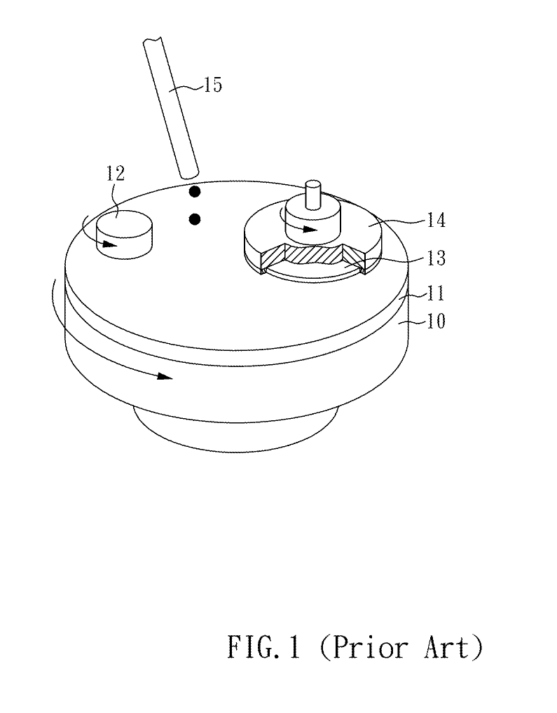

### DETAILED DESCRIPTION OF THE PREFERRED EMBODIMENT

Hereinafter, the actions and the effects of the present invention will be explained in more detail via specific examples of the invention. However, these examples are merely illustrative of the present invention and the scope of the invention should not be construed to be defined thereby.

### Example 1

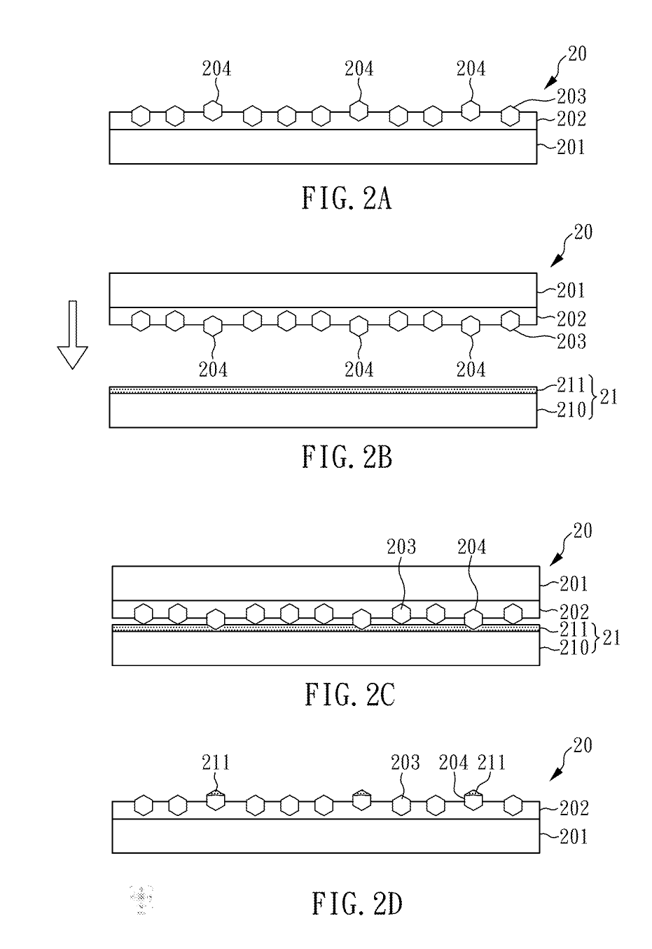

Please refer to FIGS. 2A to 2D, a flow diagram of detection method for the tip of a chemical mechanical polishing conditioner of example 1 of the present invention is shown. First, as shown in FIG. 2A, a chemical mechanical polishing conditioner 20 is provided, which comprises a substrate 201 made of stainless steel, a binding layer made of nickel-based metallic brazing material, and a plurality of abrasive particles 203 fixed on the substrate 201 by the binding layer 202; wherein the abrasive particles may have a particle size of 200 μm, and an installation method of abrasive particles 203 may be a known diamond distribution technique, for example, template distribution. The spacing and arrangement of the abrasive particles 203 may be controlled by the template (not shown in figure). Besides, a few of abrasive particles 204 with a particular protruding height are present on the chemical mechanical polishing conditioner 20 simultaneously.

Further, as shown in FIG. 2 B, a dyeing apparatus 21 is provided, which comprises a dyeing layer 211 and a dyeing platform 210, wherein the dyeing layer 211 is a black carbon paper including carbon, and the dyeing platform 210 may be a plastic film, such as polymethylmethacrylate (PMMA), polycarbonate (PC) and polyethylene terephthalate (PET); or the dyeing platform 210 may be a metal platform. The dyeing platform 210 has a flat surface and is positioned the bottom of the dyeing layer 211, so that the dyeing platform 210 may provide for the dyeing layer 211 remaining a flat surface. Then, please refer to FIGS. 2B and 2C together, the abrasive particles 203 of the chemical mechanical polishing conditioner 20 are toward the dyeing apparatus 21 and provide a downward force (as shown in direction of arrow of FIG. 2B), so that the chemical mechanical polishing conditioner 20 is contacted with the dyeing layer 211.

Finally, as shown in FIG. 2 D, the chemical mechanical polishing conditioner (not shown in figure) and the dyeing apparatus 21 are separated, so that a part of the abrasive particles 204 with a particular protruding height form the dyeing abrasive particles adhered the dyeing layer 211 on their surface, and the dyeing abrasive particles are determined as a defect of destroying the flatness of chemical mechanical polishing conditioner.

In the detection method for the tip of a chemical mechanical polishing conditioner of example 1 of the present invention, the particular protruding height may be determined by a thickness of the dyeing layer or a downward force of the chemical mechanical polishing conditioner contracted with the dyeing layer. In example 1, the particular protruding height is determined by a thickness of the dyeing layer; wherein the thickness of the dyeing layer may be 20 μm. Therefore, the particular protruding height is the same as 20 μm.

In the detection method for the tip of a chemical mechanical polishing conditioner of example 1 of the present invention, the action mode of the downward force is a gravity formed by itself weight of the chemical mechanical polishing conditioner, and the movement mode of the downward force is that a pressure is applied to a non-fixed position of the dyeing layer by the chemical mechanical polishing conditioner. Besides, a removing device (not shown in figure) is further including in aforementioned example 1, wherein the removing device may be a high-power laser, a water jet device, an endpoint oscillator or an artificial shave tool, which is used for removing the aforementioned abrasive particles with a particular protruding height (namely, the dyeing abrasive particles) from the chemical mechanical polishing conditioner, and thereby avoiding scratches and breakages produced on the polishing pad due to abrasive particles with a particular protruding height during a chemical mechanical polishing process.

Hereby, in the detection method for the tip of a chemical mechanical polishing conditioner of example 1 of the present invention, the method further comprises that the detection apparatus for the tip of a chemical mechanical polishing conditioner is used simultaneously to perform the detection. Please refer to FIGS. 2A to 2D together, the detection apparatus comprises a dyeing apparatus 21 comprising a dyeing layer 211 and dyeing platform 210; and a chemical mechanical polishing conditioner 20 comprising a substrate 201, a binding layer 202, and a plurality of abrasive particles 203 fixed on the substrate 201 by the binding layer 202; wherein the abrasive particles 203 of the chemical mechanical polishing conditioner 20 are toward the dyeing apparatus 21, and the chemical mechanical polishing conditioner 20 is contacted with the dyeing layer 211 by a downward force. The chemical mechanical polishing conditioner 20 and the dyeing apparatus 21 are separated, so that the abrasive particles 204 with a particular protruding height form the dyeing abrasive particles adhered the dyeing layer 211 on their surface, and the dyeing abrasive particles are determined as a defect of destroying the flatness of chemical mechanical polishing conditioner.

### Example 2

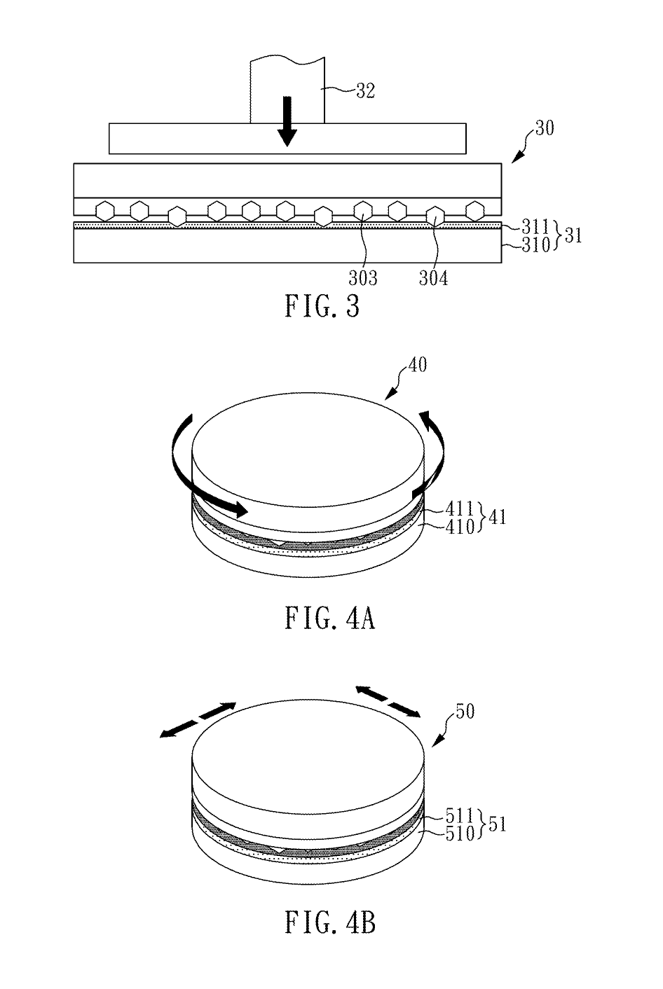

Please refer to FIGS. 3, a flow diagram of detection method for the tip of a chemical mechanical polishing conditioner of example 1 of the present invention is shown. The detection methods for the tip of a chemical mechanical polishing conditioner of Example 2 is substantially the same as the above Example 1, but the differences are as following. In the detection methods for the tip of a chemical mechanical polishing conditioner of Example 1, the action mode of the downward force is the gravity formed by itself weight of the chemical mechanical polishing conditioner, but in example 2, the downward force is that an additional downward gravity is applied to the chemical mechanical polishing conditioner. As shown in FIG. 3, the abrasive particles 303 of the chemical mechanical polishing conditioner 30 are toward the dyeing apparatus 31. Further, the dyeing apparatus 31 comprises a dyeing layer 311 and a dyeing platform 310, and a downward force (as shown in direction of arrow of FIG. 3) is provided by a pressure device 32, so that the chemical mechanical polishing conditioner 30 is contacted with the dyeing layer 311, meanwhile a part of the abrasive particles 304 with a particular protruding height form the dyeing abrasive particles adhered the dyeing layer 311 on their surface, and the dyeing abrasive particles are determined as a defect of destroying the flatness of chemical mechanical polishing conditioner.

### Examples 3 and 4

Please refer to FIGS. 4A and 4B, schematic diagrams of detection method for the tip of a chemical mechanical polishing conditioner of examples 3 and 4 of the present invention are shown. The detection methods for the tip of a chemical mechanical polishing conditioner of Examples 3 and 4 are substantially the same as the above Example 1, but the differences are as following. In the detection methods for the tip of a chemical mechanical polishing conditioner of Example 1, the movement mode of the downward force is that a pressure is applied to a fixed position of the dyeing layer by the chemical mechanical polishing conditioner, but in Examples 3 and 4, the movement mode of the downward force is that a pressure is applied to a non-fixed position of the dyeing layer by the chemical mechanical polishing conditioner.

As shown in FIG. 4A, in Example 3, the abrasive particles (not shown in figure) on the chemical mechanical polishing conditioner 40 are toward the dyeing apparatus 41. The dyeing apparatus 41 comprises a dyeing layer 411 and a dyeing platform 410, and the chemical mechanical polishing conditioner 40 are contacted with the dyeing apparatus 41 by providing a downward force; wherein the movement mode of downward force is that a pressure is applied to a non-fixed position of the dyeing layer 411 by the chemical mechanical polishing conditioner 40, and the non-fixed position represents that the chemical mechanical polishing conditioner 40 moves in a rotation direction movement (as shown in direction of arrow of FIG. 4A) under the dyeing layer 411, so that a part of the abrasive particles with a particular protruding height form the dyeing abrasive particles adhered the dyeing layer 411 on their surface, and the dyeing abrasive particles are determined as a defect of destroying the flatness of chemical mechanical polishing conditioner.

As shown in FIG. 4B, in Example 4, the abrasive particles (not shown in figure) on the chemical mechanical polishing conditioner 50 are toward the dyeing apparatus 51. The dyeing apparatus 51 comprises a dyeing layer 511 and a dyeing platform 510, and the chemical mechanical polishing conditioner 50 is contacted with the dyeing apparatus 51 by providing a downward force; wherein the movement mode of downward force is that a pressure is applied to a non-fixed position of the dyeing layer 511 by the chemical mechanical polishing conditioner 50, and the non-fixed position represents that the chemical mechanical polishing conditioner 50 moves in a rectilinear directions crisscrossing movement (as shown in direction of arrow of FIG. 4B) under the dyeing layer 511, so that a part of the abrasive particles with a particular protruding height form the dyeing abrasive particles adhered the dyeing layer 511 on their surface, and the dyeing abrasive particles are determined as a defect of destroying the flatness of chemical mechanical polishing conditioner.

It should be understood that these examples are merely illustrative of the present invention and the scope of the invention should not be construed to be defined thereby, and the scope of the present invention will be limited only by the appended claims.

What is claimed is:

1. A detection method for the tip of a chemical mechanical polishing conditioner, comprising:
providing a dyeing device comprising a dyeing layer;
providing a chemical mechanical polishing conditioner comprising a substrate, a binding layer, and a plurality of abrasive particles; and the abrasive particles fixed on the substrate by the bonding layer;
making the abrasive particles of the chemical mechanical polishing conditioner toward the dyeing apparatus and providing a downward force, so that the chemical mechanical polishing conditioner is contacted with the dyeing layer; and
separating the chemical mechanical polishing conditioner and the dyeing apparatus, so that the abrasive particles with a particular protruding height form dyeing abrasive particles adhered the dyeing layer on their surfaces, and the dyeing abrasive particles are determined as a defect of destroying the flatness of chemical mechanical polishing conditioner.

2. The detection method for the tip of a chemical mechanical polishing conditioner of claim 1, wherein the dyeing layer is a powder dyeing layer, an ink dyeing layer, or a fluorescent dyeing layer.

3. The detection method for the tip of a chemical mechanical polishing conditioner of claim 2, wherein the powder dyeing layer is a carbon paper.

4. The detection method for the tip of a chemical mechanical polishing conditioner of claim 1, wherein the colors of the dyeing layer and the dyeing abrasive particles are black, red, blue, or various dayglo.

5. The detection method for the tip of a chemical mechanical polishing conditioner of claim 1, wherein the dyeing apparatus further comprises a dyeing platform providing for the dyeing layer remaining a flat surface.

6. The detection method for the tip of a chemical mechanical polishing conditioner of claim 1, wherein the downward force is that a pressure is applied to a fixed position of the dyeing layer by the chemical mechanical polishing conditioner.

7. The detection method for the tip of a chemical mechanical polishing conditioner of claim 1, wherein the downward force is that a pressure is applied to a non-fixed position of the dyeing layer by the chemical mechanical polishing conditioner.

8. The detection method for the tip of a chemical mechanical polishing conditioner of claim 7, wherein the non-fixed position is a rotation direction movement, a rectilinear direction movement, or a plurality of rectilinear directions crisscrossing movement.

9. The detection method for the tip of a chemical mechanical polishing conditioner of claim 1, wherein the downward force is a gravity formed by itself weight of the chemical mechanical polishing conditioner.

10. The detection method for the tip of a chemical mechanical polishing conditioner of claim 1, wherein the downward force is that an additional downward gravity is applied to the chemical mechanical polishing conditioner.

11. The detection method for the tip of a chemical mechanical polishing conditioner of claim 1, wherein the particular protruding height is determined by a thickness of the dyeing layer.

12. The detection method for the tip of a chemical mechanical polishing conditioner of claim 1, wherein the particular protruding height is 5 μm to 200 μm.

13. The detection method for the tip of a chemical mechanical polishing conditioner of claim 1, wherein the particular protruding height is 10 μm to 30 μm.

14. The detection method for the tip of a chemical mechanical polishing conditioner of claim 1, the detection method further comprises a removing device for removing the abrasive particles with a particular protruding height from the chemical mechanical polishing conditioner.

15. A detection apparatus for the tip of a chemical mechanical polishing conditioner, comprising:
a dyeing apparatus comprising dyeing layer; and
a chemical mechanical polishing conditioner comprising a substrate, a binding layer, and a plurality of abrasive particles fixed on the substrate by the binding layer;
wherein these abrasive particles on the chemical mechanical polishing conditioner are toward the dyeing apparatus, and the chemical mechanical polishing conditioner is contacted with the dyeing layer by a downward force; and the chemical mechanical polishing conditioner and the dyeing apparatus are separated, so that the abrasive particles with a particular protruding height form dyeing abrasive particles adhered the dyeing layer on their surfaces, and the dyeing abrasive particles are determined as a defect of destroying the flatness of chemical mechanical polishing conditioner.

16. The detection apparatus for the tip of a chemical mechanical polishing conditioner of claim 15, wherein the dyeing layer is a powder dyeing layer, an ink dyeing layer, or a fluorescent dyeing layer.

17. The detection apparatus for the tip of a chemical mechanical polishing conditioner of claim 16, wherein the powder dyeing layer is a carbon paper.

18. The detection apparatus for the tip of a chemical mechanical polishing conditioner of claim 15, wherein the colors of the dyeing layer and the dyeing abrasive particles are black, red, blue, or various dayglo.

19. The detection apparatus for the tip of a chemical mechanical polishing conditioner of claim 15, wherein the dyeing apparatus further comprises a dyeing platform having a flat surface and positioned the bottom of the dyeing layer.

20. The detection apparatus for the tip of a chemical mechanical polishing conditioner of claim 15, wherein the material of dyeing platform is a resin material, a ceramics material, or a metal material.

21. The detection apparatus for the tip of a chemical mechanical polishing conditioner of claim 15, the detection apparatus further comprises a removing device, and the removing device is a high power laser, a water jet device, an endpoint oscillator or an artificial shave tool.

22. The detection apparatus for the tip of a chemical mechanical polishing conditioner of claim 15, wherein the material of the substrate is stainless steel.

23. The detection apparatus for the tip of a chemical mechanical polishing conditioner of claim 15, wherein the binding layer may be a brazing layer, a resin layer, a electroplating layer, or a ceramic layer.

24. The detection apparatus for the tip of a chemical mechanical polishing conditioner of claim 23, wherein the brazing layer is at least one selected from the group consisting of iron, cobalt, nickel, chromium, manganese, silicon, aluminum, copper, and combinations thereof.

25. The detection apparatus for the tip of a chemical mechanical polishing conditioner of claim 15, wherein the abrasive particles are diamonds or cubic boron nitride.

26. The detection apparatus for the tip of a chemical mechanical polishing conditioner of claim 15, wherein the abrasive particles have a particle size of 30 to 600 μm.
